(19) United States
(12) Patent Application Publication
(10) Pub. No.: US 2020/0156339 A1
(43) Pub. Date: May 21, 2020

(54) BEAD CORE MANUFACTURING DEVICE

(71) Applicant: Toyo Tire Corporation, Itami-shi (JP)

(72) Inventor: Akira Sasaki, Itami-shi (JP)

(73) Assignee: Toyo Tire Corporation, Itami-shi (JP)

(21) Appl. No.: 16/681,918

(22) Filed: Nov. 13, 2019

(30) Foreign Application Priority Data
Nov. 15, 2018 (JP) 2018-214818

(51) Int. Cl. B29D 30/48

(52) U.S. Cl. CPC B29D 30/48; B29D 2030/485

(57) ABSTRACT

Provided is a bead core manufacturing device for manufacturing a bead core formed by annularly winding a bead wire coated with unvulcanized rubber in a plurality of turns, including a rotary support body provided to be radially expanded and retracted in a radial direction thereof and configured to allow the bead wire to be wound around an outer peripheral surface thereof; and a clamping device configured to press a winding-ending end portion of the bead wire against the bead core while sandwiching a part of the bead core, which includes the winding-ending end portion of the bead wire, in a widthwise direction thereof.

### TECHNICAL FIELD

The present invention relates to a device for manufacturing a bead core for a pneumatic tire.

### BACKGROUND ART

As bead cores for pneumatic tires, a bead core is known, in which one bead wire coated with unvulcanized rubber is annually wound in a plurality of turns. A force causing the bead wire to be straightly stretched is likely to be exerted on the bead wire. Therefore, the bead wire is previously reformed by plastically deforming the bead wire so as to adapt the bead wire to a winding direction thereof upon building of the bead core. Such a reforming process suppresses to some extent a force, which causes a leading end portion (winding-starting end portion) and a trailing end portion (winding-ending end portion), in a winding direction, of the bead wire of the bead core to radially jump up from a predetermined position.

However, the bead wire is likely to be subject to torsional deformation about an axial direction thereof during the process. If the bead wire in such a state is built into the bead core, the reforming direction is likely to be twisted by a residual stress of torsional deformation. Therefore, the leading end portion and trailing end portion of the bead wire of the bead core are likely to be displaced from the predetermined position and also to jump out of the bead core in a widthwise direction thereof.

On the contrary, for example, as described in JP-A-2010-120587, a case is known where a cord is helically wound on a winding-ending end portion of a bead wire to prevent the winding-ending end portion from jumping up. Further, for example, as described in JP-A-2016-88259, a case is also known where a sheet-shaped member with a plurality of wires coated with rubber is wound on a winding-ending end portion of a bead wire to prevent the winding-ending end portion from jumping up.

### SUMMARY OF THE INVENTION

However, in the case where the cord or sheet-shaped rubber member is wound on the winding-ending end portion of the bead wire, such a member different from the bead wire is wound. Therefore, an additional process other than the process for building the bead core is required, and thus the manufacturing time thereof is likely to be extended.

In addition, when the bead core is conveyed to a device for winding the cord or sheet-shaped rubber member after the bead core is built, the bead core with the winding-ending end portion of the bead wire jumped up has to be conveyed, thereby making it difficult to handle the bead core.

The present invention has been made keeping in mind the above problems, and an object thereof is to provide a bead core manufacturing device, which can prevent a winding-ending end portion of a bead wire from jumping up without winding a cord or sheet-shaped rubber member on the winding-ending end portion of the bead wire.

According to the present invention, there is provided a bead core manufacturing device for manufacturing a bead core formed by annularly winding a bead wire coated with unvulcanized rubber in a plurality of turns, including: a rotary support body provided to be radially expanded and retracted in a radial direction thereof and configured to allow the bead wire to be wound around an outer peripheral surface thereof; and a clamping device configured to press a winding-ending end portion of the bead wire against the bead core while sandwiching a part of the bead core, which includes the winding-ending end portion of the bead wire, in a widthwise direction thereof.

In the present invention, the clamping device is provided to press the winding-ending end portion of the wire against the bead core while sandwiching a part of the bead core, which includes the winding-ending end portion of the wire, in the widthwise direction thereof. Therefore, it is possible to prevent the winding-ending end portion of the bead wire from jumping up without winding a cord or sheet-shaped rubber member on the vicinity of the winding-ending end portion of the bead wire.

### BRIEF DESCRIPTION OF THE DRAWINGS

FIG. 1 is a schematic configuration view of a bead core manufacturing device according to a first embodiment of the present invention.

FIG. 2 is a schematic plan view showing a main part of the bead core manufacturing device of FIG. 1.

FIG. 3 is a view showing a withdrawing device and a clamping device as viewed from the side of a rotary support body.

FIG. 4 is a schematic configuration view of the bead core manufacturing device showing a state where a chuck unit has been moved to a bonding position.

FIG. 5 is a schematic configuration view of the bead core manufacturing device showing a state where a bead core is being formed around an outer peripheral surface of the rotary support body.

FIG. 6 is a sectional view taken along a line A-A in FIG. 5.

FIG. 7 is a schematic configuration view of the bead core manufacturing device showing a state where a bead wire has been cut.

FIG. 8 is a schematic configuration view of the bead core manufacturing device showing a state where a winding-ending end portion of the bead wire has been wound around the rotary support body.

FIG. 9 is a sectional view taken along a line B-B in FIG. 8.

FIG. 10 is a schematic configuration view of the bead core manufacturing device showing a state where segments of the rotary support body have been radially retracted.

FIG. 11 is a plan view of a clamping device of a bead core manufacturing device according to a second embodiment.

FIG. 12 is an enlarged view of a main part of a bead core manufacturing device according to a variant of the present invention.

### DETAILED DESCRIPTION OF THE INVENTION

### First Embodiment

Hereinafter, a first embodiment of the present invention will be described in detail with reference to the accompanying drawings.

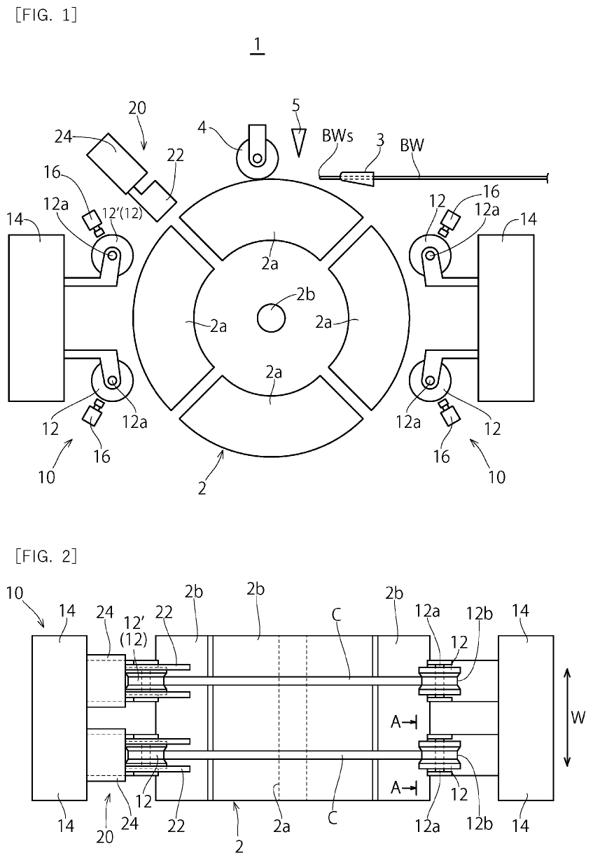

A bead core manufacturing device 1 according to the present embodiment is a device for manufacturing an annular bead core C by winding a bead wire BW, which has a metal wire coated with unvulcanized rubber, around an outer peripheral surface of a rotary support body 2. As shown in FIGS. 1 to 3, the bead core manufacturing device 1 includes the rotary support body 2, a chuck unit 3, a pressing roller 4, a cutter 5, a withdrawing device 10 and a clamping device 20.

The rotary support body 2 is a cylindrical building drum configured to be rotatable about a rotational shaft 2b. The rotary support body 2 is split into a plurality of segments 2a along a circumferential direction. The plurality of segments 2a constituting the rotary support body 2 is configured to be expanded and retracted. The rotary support body 2 has a servomotor (not shown) as a driving source so as to adjust a rotation angle thereof when winding the bead wire BW therearound.

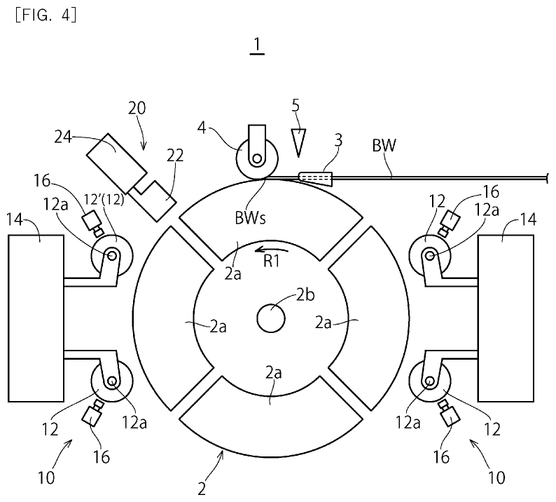

The chuck unit 3 is configured to be moved between a retracted position, at which the chuck unit 3 is away from the rotary support body 2 (see FIG. 1), and a bonding position, at which the chuck unit 3 is near the outer peripheral surface of the rotary support body 2 (see FIG. 4), by a moving mechanism (not shown). Also, the chuck unit 3 is configured to be moved in an axial direction of the rotary support body 2 (in a direction parallel to the rotational shaft 2b) by the moving mechanism (not shown).

The chuck unit 3 can move from the retracted position to the bonding position while holding an end portion of the bead wire BW. In this way, the chuck unit 3 supplies a leading end portion BWs of the bead wire BW between the outer peripheral surface of the rotary support body 2 and the pressing roller 4 and then bonds the leading end portion BWs of the bead wire BW to the outer peripheral surface of the rotary support body 2. Thereafter, as the rotary support body 2 rotates about the rotational shaft 2b, the bead wire BW is wound around the outer peripheral surface of the rotary support body 2. Each time the rotary support body 2 rotates one time, the moving mechanism (not shown) moves the chuck unit 3 in the axial direction of the rotary support body 2 by a predetermined distance (feed pitch). Each time the bead wire BW goes around the outer peripheral surface of the rotary support body 2, the bead wire BW is moved in the axial direction of the rotary support body 2 while being guided by the chuck unit 3 so as to be helically wound therearound, thereby forming the bead core C on the outer peripheral surface of the rotary support body 2.

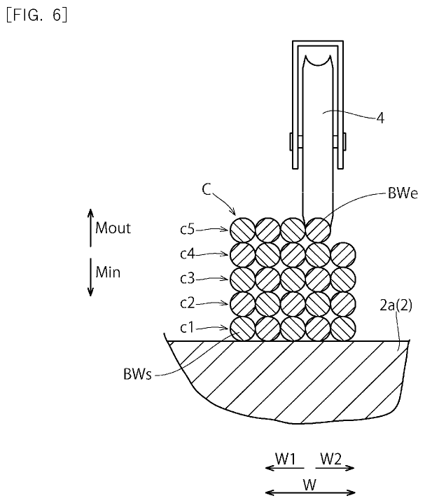

The pressing roller 4 is configured to press the bead wire BW, which has been wound by rotation of the rotary support body 2, against the outer peripheral surface of the rotary support body 2 (in an inward radial direction of the rotary support body 2) (see FIG. 6). As a result, the bead wire BW wound around the outer peripheral surface of the rotary support body 2 is brought into close contact therewith in radial direction.

The cutter 5 is configured to cut the bead wire BW at a location where the bead wire BW has been wound around the outer peripheral surface of the rotary support body 2 by a predetermined length.

The withdrawing device 10 is a device for withdrawing the bead core C, which has been formed on the outer peripheral surface of the rotary support body 2, from the rotary support body 2. The withdrawing device 10 has a plurality of holding rollers 12 for holding the bead core C formed on the outer peripheral surface of the rotary support body 2, a moving mechanism 14 for moving the holding rollers 12, and brakes 16 for preventing rotation of the holding rollers 12.

For one rotary support body 2, a plurality of, preferably three or more, holding rollers 12 are provided to be spaced from each other in the circumferential direction of the rotary support body 2. Outer peripheral surfaces of the holding rollers 12 abut against an outer peripheral surface of the bead core C formed on the rotary support body 2 at a plurality of locations spaced from each other in the circumferential direction thereof. In this way, the holding rollers 12 hold the bead core C. Each of the holding rollers 12 is rotatably attached to a respective rotational shaft 12a parallel to the rotational shaft 2b of the rotary support body 2. The holding rollers 12 are formed as a resin cylindrical body and are made of a material softer than the outer peripheral surface of the rotary support body 2.

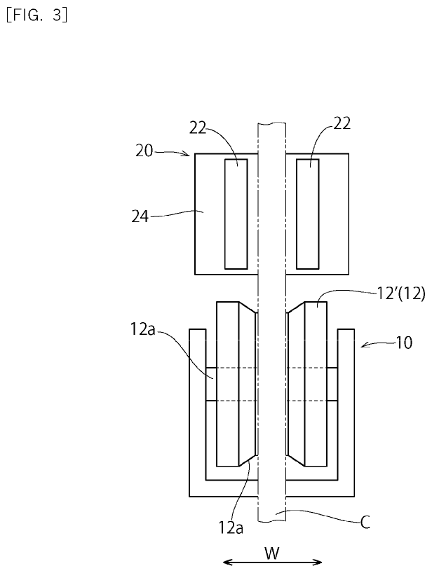

As shown in FIGS. 2 and 3, as a preferable mode, an annular concave groove 12b allowing the bead core C to be fitted therein is formed on the outer peripheral surface of each of the holding rollers 12.

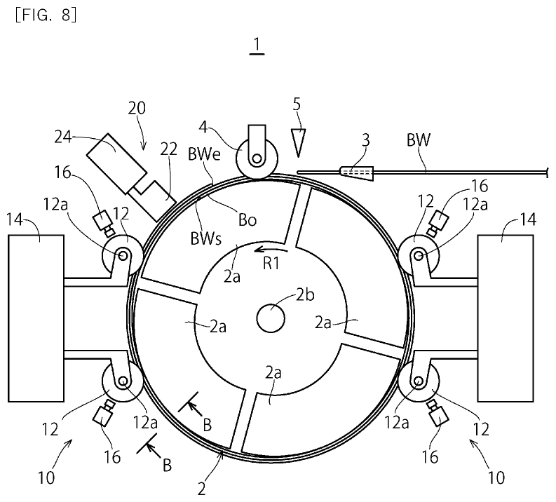

Also, in a state where the holding rollers 12 abut against the bead core C as shown in FIG. 8, the plurality of holding rollers 12 are preferably arranged such that the holding rollers 12 are positioned at locations symmetric with respect to the rotational shaft 2b, as viewed in a direction of the rotational shaft 2b of the rotary support body 2.

The moving mechanism 14 has an actuator, such as a cylinder. The moving mechanism 14 is configured to cause the plurality of holding rollers 12 to synchronously move close to or away from the bead core C formed on the outer peripheral surface of the rotary support body 2.

The brake 16 has a pad configured to be moved close to or away from the holding roller 12 by a cylinder. The brake 16 is configured to allow the holding roller 12 to freely rotate if the pad is away from the holding roller 12 and to prevent rotation of the holding roller 12 if the pad abuts against the holding roller 12. This brake 16 is provided for each of the plurality of holding rollers 12.

As shown in FIG. 3, the clamping device 20 has a pair of holding portions 22 arranged to be spaced from each other in a widthwise direction W of the bead core C, and a clamp drive portion 24 for moving the pair of holding portions 22.

The pair of holding portions 22 are shaped and sized to sandwich therebetween the whole of an overlap region Bo, as described below, and are configured to abut against widthwise side surfaces of the bead core C and thus to press the bead core C inward in the widthwise direction thereof.

The holding portions 22 are formed as a resin plate-shaped body and are made of a material softer than the outer peripheral surface of the rotary support body 2.

The clamp drive portion 24 has a biaxial actuator, such as a cylinder. The clamp drive portion 24 is configured to move the pair of holding portions 22 close to or away from each other, thereby causing the pair of holding portions 22 to come in contact with the widthwise side surfaces of the bead core C or to be separated from the widthwise side surfaces of the bead core C. Also, the clamp drive portion 24 is configured to move the pair of holding portions 22 in a radial direction of the bead core C, thereby causing the pair of holding portions 22 to move close to or away from the bead core C formed on the outer peripheral surface of the rotary support body 2.

According to the present invention, the clamping device 20 may be provided at any location. In the present invention, the clamping device 20 is preferably provided in the vicinity of the outer peripheral surface of the rotary support body 2, so that the holding portions 22 can sandwich the bead core C supported on the outer peripheral surface of the rotary support body 2 or the holding portions 22 can sandwich the bead core C held by the withdrawing device 10. More preferably, the clamping device 20 is provided in front of the pressing roller 4 in a rotation direction R1 of the rotary support body 2. Particularly preferably, as shown in FIG. 4, the clamping device 20 is provided in front of the pressing roller 4 in the rotation direction R1 of the rotary support body 2 and provide behind one holding roller 12′ of the holding rollers 12 of the withdrawing device 10 in the rotation direction of the rotary support body 2, which is provided at a location closest to the pressing roller 4 in the rotation direction R1 of the rotary support body 2.

Next, operation of the bead core manufacturing device 1 as described above will be described.

First, in a state where the pressing roller 4 is near the outer peripheral surface of the rotary support body 2 and the rotary support body 2 is radially expanded, the chuck unit 3 moves from the retracted position, as shown in FIG. 1, to the bonding position, as shown in FIG. 4, while holding the bead wire BW, thereby inserting the leading end portion BWs of the bead wire BW between the outer peripheral surface of the rotary support body 2 and the pressing roller 4.

Meanwhile, the holding rollers 12 of the withdrawing device 10 and the holding portions 22 of the clamping device 20 are kept at a distance from the outer peripheral surface of the rotary support body 2, so as to prevent them from coming in contact with the bead wire BW wound around the rotary support body 2.

Then, once a winding-starting end portion BWs of the bead wire BW has been inserted between the rotary support body 2 and the pressing roller 4, the chuck unit 3 releases the held bead wire BW.

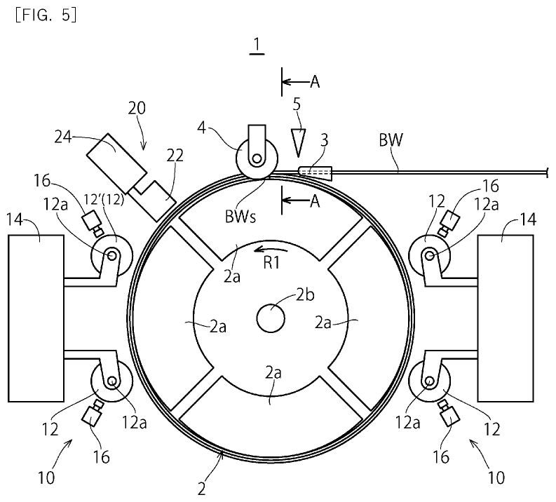

Subsequently, as shown in FIG. 5, the servomotor is activated to rotate the rotary support body 2 in one direction R1 (in a counterclockwise in FIG. 5). Also, each time the rotary support body 2 rotates one time, the chuck unit 3 moves the bead wire BW in the axial direction of the rotary support body 2. In this way, the bead core manufacturing device 1 forms a bead core C on the outer peripheral surface of the rotary support body 2 by helically winding the bead wire BW therearound.

In the present embodiment, as illustrated in FIG. 6, the bead core C is formed in such a manner that the winding-starting end portion BWs of the bead wire BW is positioned on one widthwise side (the left side in FIG. 6) W1 of the bead core C and also on a radially inward side Min thereof, and a winding-ending end portion BWe is positioned on the other widthwise side (the right side in FIG. 6) W2 of the bead core C and also on a radially outward side Mout thereof.

Specifically, after the winding-starting end portion BWs of the bead wire BW is positioned at a predetermined location on the outer peripheral surface of the rotary support body 2, the bead wire BW is wound up to a fifth turn toward the other widthwise side W2 of the bead core C, thereby forming a first layer.

Also, after a sixth turn is wound over the fifth turn, the bead wire BW is wound over a first layer c1 up to a tenth turn toward the one widthwise side W1 of the bead core C, thereby forming a second layer c2. Thereafter, like the second layer c2, the bead wire BW is wound over the second layer c2 from an eleventh turn up to a fifteenth turn to form a third layer c3, the bead wire BW is wound over the third layer c3 from a sixteenth turn up to a twentieth turn to form a fourth layer c4, and then the bead wire BW is wound over the fourth layer c4 from a twenty-first turn up to a twenty-fourth turn to form a fifth layer c5.

Meanwhile, the bead wire BW has to be wound such that no gap forms between bead wires BW adjacent to each other in the widthwise direction W of the bead core C.

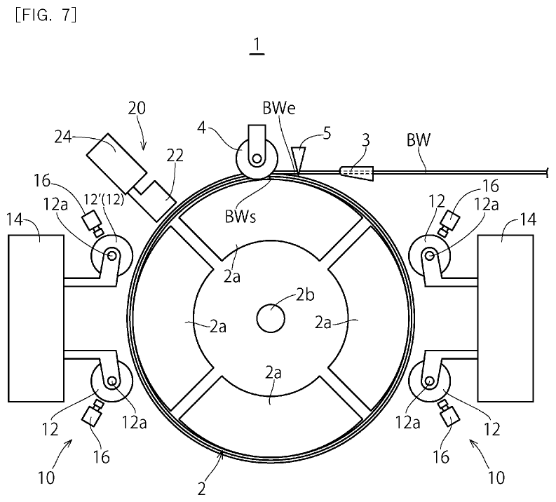

Then, once forming of the fifth layer c5 of the bead core C has been ended, the servomotor is stopped and thus winding of the bead wire BW is stopped. Then, as shown in FIG. 7, the chuck unit 3 moves from the bonding position to the retracted position and also holds the bead wire BW. Then, the cutter 5 cuts the bead wire BW to form the winding-ending end portion BWe of the bead wire BW.

Once the cutter 5 has cut the bead wire BW, as shown in FIG. 8, the servomotor is activated to rotate the rotary support body 2 in one rotation direction R1. In this way, the winding-ending end portion BWe of the bead wire BW is wound around the rotary support body 2 and also pressed toward the radially inward side Min by the pressing roller 4.

Meanwhile, a location, at which the bead wire BW is cut, is preferably set to obtain such a bead core C that an overlap region Bo is formed by overlapping the winding-ending end portion BWe and the winding-starting end portion BWs of the bead wire BW with each other over a predetermined length (e.g., 5 to 25 mm) in a circumferential direction of a tire (see FIG. 8).

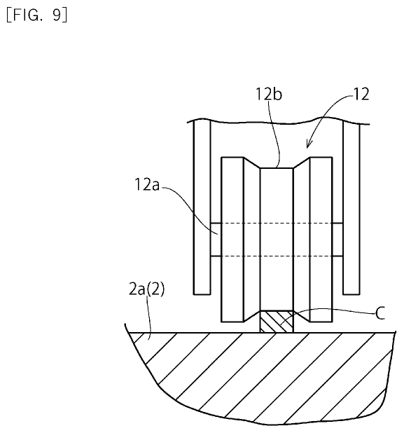

Further, while the rotary support body 2 rotates, the moving mechanism 14 of the withdrawing device 10 causes the plurality of holding rollers 12 to synchronously move close to the bead core C to the extent that, as shown in FIGS. 8 and 9, the outer peripheral surfaces of the holding rollers 12 abut against the outer peripheral surface of the bead core C.

In the present embodiment, the bead core C is fitted in the concave grooves 12b provided on the outer peripheral surfaces of the holding rollers 12, so that the bead core C is sandwiched between the plurality of holding rollers 12 and the rotary support body 2. As a result, the plurality of holding rollers 12 rotate along with rotation of the rotary support body 2.

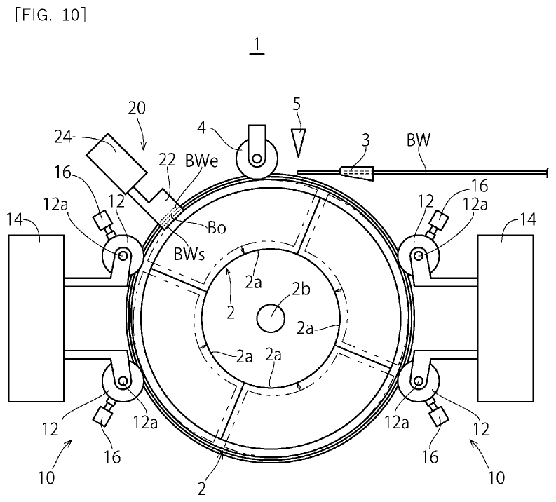

Further, as shown in FIG. 10, the segments 2a of the rotary support body 2 are radially retracted with the bead core C sandwiched between the plurality of holding rollers 12 and the rotary support body 2. As a result, the bead core C is transferred from the rotating rotary support body 2 to the plurality of holding rollers 12. That is, the bead core C is transferred from the rotary support body 2 to the holding rollers 12 while being rotated.

Also, the pressing roller 4 is moved away from the outer peripheral surface of the rotary support body 2 at the same time as the segments 2a are radially retracted.

While the bead core C is transferred from the rotary support body 2 to the plurality of holding rollers 12 as described above, the clamp drive portion 24 of the clamping device 20 moves the pair of holding portions 22 toward the radially inward side Min, so that the bead core C is positioned between the pair of holding portions 22 (see FIG. 10).

Then, once transferring of the bead core C from the rotary support body 2 to the holding rollers 12 has been completed, the brakes 16 cause the pads to abut against the respective holding rollers 12, thereby stopping the holding rollers 12.

In the present embodiment, the brakes 16 stop the holding rollers 12 in such a manner that the overlap region Bo, in which the winding-starting end portion BWs and the winding-ending end portion BWe of the bead wire BW overlap with each other in the circumferential direction, is positioned between the pair of holding portions 22 provided on the clamping device 20.

Then, once the holding rollers 12 have stopped, the clamp drive portion 24 of the clamping device 20 moves the pair of holding portions 22 close to each other, so that the pair of holding portions 22 sandwich the whole of the overlap region Bo of the bead core C in the widthwise direction W of the bead core C.

Then, the clamp drive portion 24 of the clamping device 20 moves the pair of holding portions 22 away from each other to release the held bead core C and also moves the pair of holding portions 22 toward the radially outward side Mout. In this way, building of the bead core C is completed.

In the bead core manufacturing device 1 of the present embodiment as described above, the holding portions 22 provided on the clamping device 20 sandwich the winding-ending end portion BWe of the bead wire BW in the widthwise direction W. Therefore, the winding-ending end portion BWe of the bead wire BW can come in close contact with the bead wire BW adjacent thereto in the widthwise direction W, thereby preventing the winding-ending end portion BWe of the bead wire BW from jumping up.

Also, in the present embodiment, the holding portions 22 sandwich the winding-ending end portion BWe of the bead wire BW in the widthwise direction W after the bead core C is transferred from the rotary support body 2 to the withdrawing device 10, thereby ensuring that the holding portions 22 can sandwich the entire bead core C in the radial direction without interference with the rotary support body 2.

Further, in the present embodiment, the holding portions 22 sandwich the entire overlap region Bo in the widthwise direction W, in which the winding-ending end portion BWe and the winding-starting end portion BWs of the bead wire BW overlap with each other in the circumferential direction of the tire. Therefore, in addition to the winding-ending end portion BWe of the bead wire BW, the winding-staring end portion BWs can also be brought into close contact with the bead wire BW adjacent thereto in the widthwise direction W, thereby preventing the winding-starting end portion BWs of the bead wire BW from being separated from the bead core C.

Further, in the present embodiment, the clamping device 20 is provided in front of the pressing roller 4 in the rotation direction R1 of the rotary support body 2. In this case, it is possible to stop rotation of the bead core C immediately after the winding-ending end portion BWe of the bead wire BW is pressed toward the radially inward side Min, thereby allowing the holding portions 22 to sandwich the winding-starting end portion BWs of the bead wire BW. Therefore, useless operation can be suppressed, so that the manufacturing time of the bead core C can be shortened.

Particularly, in the present embodiment, the rotating bead core C is transferred from the rotary support body 2 to the holding rollers 12, which have a weight smaller than the rotary support body 2, thereby ensuring that rotation of the bead core C can be stopped in a short time. Therefore, in the present embodiment, the clamping device 20 can be arranged to become closer to the pressing roller 4, thereby further shortening the manufacturing time of the bead core C.

### Second Embodiment

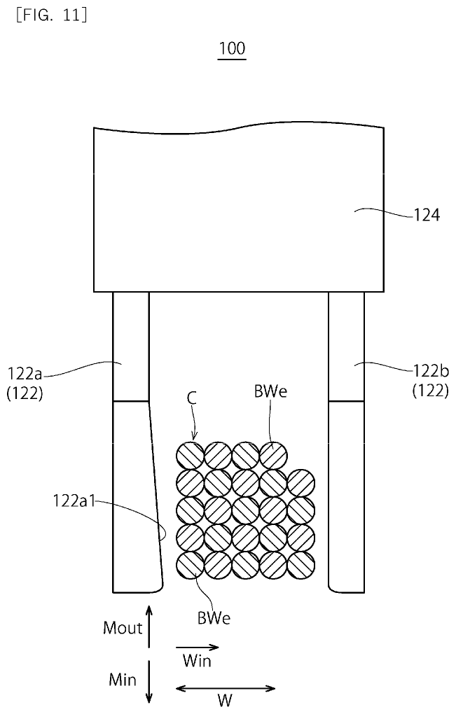

Next, a second embodiment of the present invention will be described with reference to FIG. 11. Meanwhile, description of the same parts as those of the first embodiment will be omitted and only different parts will be described.

In the present embodiment, when a pair of holding portions 122 of a clamping device 100 sandwich a bead core C, the pair of holding portions 122 press a winding-starting end portion BWs of a bead wire BW toward a radially outward side Mout as well as a widthwise inward side Win of the bead core C.

Specifically, as shown in FIG. 11, one holding portion (left holding portion in FIG. 11) 122a of the pair of holding portions 122, which comes in contact with the winding-starting end portion BWs of the bead wire BW, is configured such that a surface thereof facing the other holding portion 122b is formed as an inclined surface 112a1 inclined toward the widthwise inward side Win as it goes toward the radially inward side Min of the bead core C.

When the bead core C is formed by winding the bead wire BW around the rotary support body 2 as in the present embodiment, the bead wire BW is likely to be displaced in the circumferential direction of the rotary support body 2 immediately after winding is started. Therefore, a case is known where the winding-starting end portion BWs of the bead wire BW is reformed to be curved in the inward radial direction so that the winding-starting end portion BWs can easily follow the outer peripheral surface of the rotary support body 2. Further, in order to prevent a similar displacement, a case is also known where the winding-starting end portion BWs of the bead wire BW is inserted through a cut-out hole provided in the outer peripheral surface of the rotary support body 2 and then the winding-starting end portion BWs is fixed inside the rotary support body 2 by a clamp mechanism and the like.

If, as described above, the winding-starting end portion BWs is reformed or the winding-starting end portion BWs is fixed by the clamp mechanism, the winding-starting end portion BWs of the bead wire BW is likely to be separated from the bead core C in the inward radial direction.

However, in the present embodiment, when a clamp drive portion 124 moves the pair of holding portions 122 close to each other and thus the pair of holding portions 122 sandwich the bead core C in the widthwise direction W, the inclined surface 122a1 of the one holding portions 122a presses the winding-starting end portion BWs of the bead wire BW, which is located on the radially inward side Min of the bead core C, toward the widthwise inward side Win and also the radially outward side Mout of the bead core C. As a result, the winding-starting end portion BWs of the bead wire BW can come in tighter contact with the bead wire BW adjacent thereto in the widthwise direction W and also the radial direction, thereby preventing the winding-starting end portion BWs from being separated from the bead core C.

Meanwhile, other operations and effects are similar to those of the first embodiment and the detailed description thereof will be omitted.

### Other Embodiments

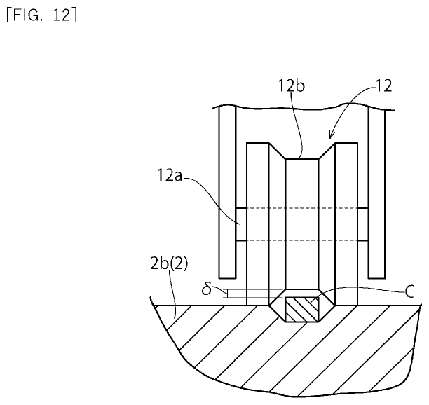

In the first and second embodiments, the moving mechanism 14 of the withdrawing device 10 causes the plurality of holding rollers 12 to synchronously move close to the bead core C, so that the outer peripheral surfaces of the holding rollers 12 abut against the outer peripheral surface of the bead core C. However, as shown in FIG. 12, the outer peripheral surfaces of the holding rollers 12 may abut against the outer peripheral surface of the rotary support body 2 in such a manner that the bead core C is arranged between the holding rollers 12 and the rotary support body 2 with a gap 5 formed between the holding rollers 12 and the bead core C.

In the state as in FIG. 12, the plurality of holding rollers 12 rotate along with rotation of the rotary support body 2 by a frictional force against the rotary support body 2. Then, from this state, the segments 2a of the rotary support body 2 are radially retracted, and also the plurality of holding rollers 12 move close to the bead core C by a distance, which corresponds to the gap 5 formed between the holding rollers 12 and the bead core C, along with radial retraction of the segments 2a. As a result, the bead core C is transferred from the rotating rotary support body 2 to the plurality of holding rollers 12, thereby allowing the bead core C to be withdrawn from the rotary support body 2.

Also, in the first and second embodiments, the case has been described where the clamping device 20 sandwiches the entire overlap region Bo in the widthwise direction W. However, for example, it is sufficient if the clamping device 20 sandwiches a part of the overlap region Bo, which includes at least the winding-ending end portion BWe of the bead wire BW.

Further, in the first and second embodiments, the clamping device 20 may sandwich the winding-ending end portion BWe of the bead wire BW after the bead core C is transferred from the rotary support body 2 to the withdrawing device 10.

Although the embodiments of the present invention have been described above, the embodiments are presented by way of example and are not intended to limit the scope of the invention. These novel embodiments can be implemented in various other modes, and also various omissions, substitutions and changes therein can be made without departing from the spirit and scope of the invention.

What is claimed is:

1. A bead core manufacturing device for manufacturing a bead core formed by annularly winding a bead wire coated with unvulcanized rubber in a plurality of turns, comprising:
a rotary support body provided to be radially expanded and retracted in a radial direction thereof and configured to allow the bead wire to be wound around an outer peripheral surface thereof; and
a clamping device configured to press a winding-ending end portion of the bead wire against the bead core while sandwiching a part of the bead core, which includes the winding-ending end portion of the bead wire, in a widthwise direction thereof.

2. The bead core manufacturing device according to claim 1, further comprising:
a withdrawing device for withdrawing the bead core, which has been formed on the outer peripheral surface of the rotary support body, from the rotary support body,
wherein the clamping device is configured to sandwich in the widthwise direction the bead core held by the withdrawing device.

3. The bead core manufacturing device according to claim 1,
wherein the bead wire is wound around the rotary support body in such a manner that a winding-starting end portion and the winding-ending end portion of the bead wire overlap with each other in a circumferential direction, and
wherein the clamping device is configured to sandwich the whole of a region where the winding-starting end portion and the winding-ending end portion of the bead wire overlap with each other in the circumferential direction.

4. The bead core manufacturing device according to claim 1, wherein the clamping device is configured to sandwich the bead core while pressing the winding-starting end portion of the bead wire toward a widthwise inward side and also a radially outward side of the bead core.

5. The bead core manufacturing device according to claim 4,
wherein the clamping device comprises a pair of holding portions configured to press the bead core toward the widthwise inward side thereof while abutting against widthwise side surfaces of the bead core, and
wherein one of the pair of holding portions has an inclined surface inclined toward the widthwise inward side as it goes toward the radially inward side of the bead core, so that the inclined surface comes in contact with the winding-starting end portion of the bead wire.

6. The bead core manufacturing device according to claim 1, further comprising:
a pressing roller for pressing the bead wire against the outer peripheral surface of the rotary support body,
wherein the clamping device is provided in front of the pressing roller in a rotation direction of the rotary support body.

7. The bead core manufacturing device according to claim 1,
wherein the withdrawing device comprises a plurality of rollers having a rotational shaft parallel to a rotational shaft of the rotary support body, and a moving mechanism for moving the plurality of rollers close to or away from the bead core formed on the outer peripheral surface of the rotary support body,
wherein the moving mechanism is configured to cause the plurality of rollers to synchronously move close to the bead core, so that the rollers abut against at least one of the rotary support body and the bead core supported by the rotary support body and also the bead core is arranged between the plurality of rollers and the rotary support body, and
wherein, while the bead core is arranged between the plurality of rollers and the rotary support body, the rotary support body is radially retracted and thus the bead core is transferred from the rotary support body to the plurality of rollers.

8. The bead core manufacturing device according to claim 2,
wherein the bead wire is wound around the rotary support body in such a manner that a winding-starting end portion and the winding-ending end portion of the bead wire overlap with each other in a circumferential direction, and
wherein the clamping device is configured to sandwich the whole of a region where the winding-starting end portion and the winding-ending end portion of the bead wire overlap with each other in the circumferential direction.

9. The bead core manufacturing device according to claim 2, wherein the clamping device is configured to sandwich the bead core while pressing the winding-starting end portion of the bead wire toward a widthwise inward side and also a radially outward side of the bead core.

10. The bead core manufacturing device according to claim 3, wherein the clamping device is configured to sandwich the bead core while pressing the winding-starting end portion of the bead wire toward a widthwise inward side and also a radially outward side of the bead core.

11. The bead core manufacturing device according to claim 2, further comprising:
a pressing roller for pressing the bead wire against the outer peripheral surface of the rotary support body,
wherein the clamping device is provided in front of the pressing roller in a rotation direction of the rotary support body.

12. The bead core manufacturing device according to claim 3, further comprising:
a pressing roller for pressing the bead wire against the outer peripheral surface of the rotary support body,
wherein the clamping device is provided in front of the pressing roller in a rotation direction of the rotary support body.

13. The bead core manufacturing device according to claim 4, further comprising:
a pressing roller for pressing the bead wire against the outer peripheral surface of the rotary support body,
wherein the clamping device is provided in front of the pressing roller in a rotation direction of the rotary support body.

14. The bead core manufacturing device according to claim 5, further comprising:
a pressing roller for pressing the bead wire against the outer peripheral surface of the rotary support body,
wherein the clamping device is provided in front of the pressing roller in a rotation direction of the rotary support body.

15. The bead core manufacturing device according to claim 2,
wherein the withdrawing device comprises a plurality of rollers having a rotational shaft parallel to a rotational shaft of the rotary support body, and a moving mechanism for moving the plurality of rollers close to or away from the bead core formed on the outer peripheral surface of the rotary support body,
wherein the moving mechanism is configured to cause the plurality of rollers to synchronously move close to the bead core, so that the rollers abut against at least one of the rotary support body and the bead core supported by the rotary support body and also the bead core is arranged between the plurality of rollers and the rotary support body, and
wherein, while the bead core is arranged between the plurality of rollers and the rotary support body, the rotary support body is radially retracted and thus the bead core is transferred from the rotary support body to the plurality of rollers.
